(19) United States
(12) Patent Application Publication
(10) Pub. No.: US 2010/0087285 A1
(43) Pub. Date: Apr. 8, 2010

(54) CHAIN TENSIONER

(76) Inventors: Seiji SATO, Iwata (JP); Satoshi Kitano, Iwata (JP); Hisashi Hayakawa, Iwata (JP)

Correspondence Address: WENDEROTH, LIND & PONACK, L.L.P., 1030 15th Street, N.W.,, Suite 400 East, Washington, DC, 20005-1503, US

(21) Appl. No.: 12/573,211

(22) Filed: Oct. 5, 2009

(30) Foreign Application Priority Data
Oct. 7, 2008 (JP) 2008-260698
Oct. 28, 2008 (JP) 2008-276857

(51) Int. Cl. F16H 7/08

(52) U.S. Cl. 474/110

(57) ABSTRACT

A chain tensioner includes a cylinder inserted in a tensioner mounting hole of an engine cover and having a flange fixed to the outer surface of the engine cover. A plunger is axially slidably mounted in the cylinder. The cylinder is formed with an oil supply passage through which hydraulic oil is introduced into a pressure chamber defined by the cylinder and the plunger. The oil supply passage includes a first hole portion extending inwardly from a mating surface of the flange facing the engine cover, and a second hole portion extending from the outer periphery of the flange to the pressure chamber and intersecting the first hole portion. An externally threaded portion of an externally threaded member is in threaded engagement with an internal thread formed on the second hole portion, thereby closing its outer open end. The externally threaded member is fixed in position with an adhesive applied to its externally threaded portion.

### BACKGROUND OF THE INVENTION

This invention relates to a chain tensioner for keeping the tension of a timing belt for driving camshafts of an automotive engine.

In a typical automotive engine, the rotation of the crankshaft is transmitted to camshafts through a timing chain to rotate the camshafts, thereby opening and closing valves of combustion chambers. In order to keep the tension of the chain in an optimum range, a tension adjusting device is frequently used which comprises a chain guide pivotable about a pivot shaft, and a chain tensioner for pressing the chain through the chain guide.

One known chain tensioner used in such a tension adjusting device is disclosed in JP Patent Publication 2007-321899A which includes a cylindrical cylinder having open and closed ends and inserted in a tensioner mounting hole formed in an engine cover with its open end located inside the engine cover. The cylinder has a flange fixed to the outer surface of the engine cover. A plunger is axially slidably mounted in the cylinder. An oil supply passage is formed in the cylinder through which hydraulic oil is introduced into a pressure chamber defined by the cylinder and the plunger from outside the cylinder. This chain tensioner further includes a check valve provided at the outlet of the oil supply passage to prevent backflow of hydraulic oil, and a return spring biasing the plunger in the direction to protrude from the cylinder. The plunger has one end thereof protruding from the cylinder and pressed against the chain.

In this chain tensioner, when the tension of the chain increases while the engine is running, under the tension of the chain, the plunger is pushed into the cylinder, thereby reducing the tension of the chain. At this time, hydraulic oil in the pressure chamber leaks through the oil leakage gap between the sliding surfaces of the plunger and the cylinder. Thus, under the dampening force due to the flow resistance of hydraulic oil flowing through the leakage gap, the plunger is pushed in slowly.

When the tension of the chain decreases while the engine is running, the plunger protrudes from the cylinder under the biasing force of the return spring, thereby eliminating slackness of the chain. At this time, hydraulic oil supplied from the oil pump is introduced into the pressure chamber, allowing the plunger to protrude quickly.

In this chain tensioner, the oil supply passage is formed in the cylinder at its portion inserted in the tensioner mounting surface, and hydraulic oil is introduced into the pressure chamber through an oil hole open to the inner periphery of the tensioner mounting hole formed in the engine cover, and through the oil supply passage. In this arrangement, the portion of the chain tensioner protruding into the interior of the engine cover tends to be long.

An object of the present invention is to provide a chain tensioner of which the portion protruding into the engine cover is shorter and which can minimize the possibility of leakage of hydraulic oil through the oil supply passage.

### SUMMARY OF THE INVENTION

In order to achieve this object, the present invention provides a chain tensioner comprising a cylindrical cylinder having an open end and a closed end and inserted in a tensioner mounting hole formed in an engine cover with the open end located in an interior of the engine cover, the cylinder having a flange fixed to an outer surface of the engine cover;

a plunger axially slidably inserted in the cylinder, wherein a pressure chamber is defined by the cylinder and the plunger, and the cylinder is formed with an oil supply passage through which hydraulic oil is introduced into the pressure chamber, a check valve provided at an outlet of the oil supply passage for preventing backflow of hydraulic oil, and a return spring biasing the plunger outwardly of the cylinder, wherein the oil supply passage comprises a first hole portion extending inwardly from a mating surface of the flange facing the engine cover, and a second hole portion extending from an outer periphery of the flange to the pressure chamber and intersecting the first hole portion, the second hole portion having an internal thread formed on its inner periphery, wherein the chain tensioner further comprises an externally threaded member having a threaded portion which is in threaded engagement with the internal thread formed on the inner periphery of the second hole portion, thereby closing an end of the second hole portion open to the outer periphery of the flange, and wherein an adhesive is applied to the threaded portion of the externally threaded member, thereby fixing the externally threaded member in position. With this arrangement, because the externally threaded member is fixed in position with an adhesive, the externally threaded member never loosens even if an operator inadvertently acts on the externally threaded member in such a manner as to loosen it.

Preferably, the externally threaded member further comprises a head having a larger diameter than the second hole portion. In this case, an aluminum flat washer is preferably disposed between the head of the externally threaded member and the flange. With this arrangement, when the externally threaded member is screwed into the second hole portion, the flat washer is deformed and brought into close contact with the head and the flange, thereby increasing liquid tightness between the head and the flange and further reducing leakage of hydraulic oil.

The externally threaded member is preferably made of aluminum so that if attempts are made to forcibly loosen the externally threaded member, its head will be easily broken, making it impossible to loosen the threaded member. This reliably prevents leakage of hydraulic oil due to such attempts.

The threaded portion of the externally threaded member has preferably a tapered thread to improve liquid tightness of the threaded portion.

The check valve may comprise a valve seat formed with a valve hole, a check ball configured to be moved into and out of contact with the valve seat, thereby selectively opening and closing the valve hole, and a retainer for restricting the moving range of the check ball. In this arrangement, because the check valve is repeatedly opened and closed as the chain vibrates, the valve seat tends to get worn. With the progression of the wear of the valve seat, a gap may develop between the check ball and the valve seat when the valve hole is closed by the check valve. Such a gap may destabilize the dampening function of the chain tensioner. Thus, in order to minimize the wear of the valve seat, a high-hardness layer is preferably formed on a contact surface of the valve seat configured to be brought into contact with the check ball. With this arrangement, the high-hardness layer slows down wear of the contact surface of the valve seat to be brought into contact with the check ball, thus reducing the possibility of formation of a gap between the check ball and the valve seat when the valve hole is closed by the check ball. This stabilizes the dampening function of the chain tensioner.

The concept of the present invention is applicable to a chain tensioner wherein the plunger is a cylindrical member having a closed end and an open end that is located inside the cylinder and formed with an internal thread on its inner periphery, and wherein the chain tensioner further comprises a screw rod mounted in the plunger with its one end protruding from the plunger and supported on the valve seat of the check valve, the screw rod having an external thread formed on its outer periphery and in threaded engagement with the internal thread of the plunger, the external thread of the screw rod and the internal thread of the plunger each comprising a pressure flank for receiving pressure when a force that tends to push the plunger into the cylinder acts on the plunger, and a clearance flank, the pressure flank having a larger flank angle than the clearance flank, whereby the external thread of the screw rod and the internal thread of the plunger have a serration-shaped axial section. In this arrangement, the high-hardness layer is preferably also formed on a contact surface of the valve seat that is in contact with the screw rod.

With this arrangement, since the contact surface of the valve seat that is in contact with the screw rod is less likely to get worn, it is possible to minimize increase in wear resistance between the screw rod and the valve seat. Thus, when the tension of the chain increases while the engine is running, the screw rod rotates reliably, allowing the plunger to reliably retract. Since the portion of the high-hardness layer on the contact surface of the valve seat to be brought into contact with the check ball can be formed simultaneously when forming the portion of the chrome diffusion layer on the contact surface of the valve seat to be brought into contact with the screw rod, the chrome diffusion layer can be formed at a low cost.

The high-hardness layer may be a chrome diffusion layer. Preferably, the chrome diffusion layer has a hardness in the range of Hv 1400 to 1800 to ensure high wear resistance of the valve seat. Preferably, the chrome diffusion layer is formed to the depth of not less than 5 μm to prevent the chrome diffusion layer from getting worn to such an extent that the base material is exposed, and to the depth of not more than 30 μm to prevent peeling of the chrome diffusion layer.

Alternatively, the high-hardness layer may be a vanadium diffusion layer. Preferably, the vanadium diffusion layer has a hardness in the range of Hv 2000 to 2600 to ensure high wear resistance of the valve seat. Preferably, the vanadium diffusion layer is formed to the depth of not less than 5 μm to prevent the vanadium diffusion layer from getting worn to such an extent that the base material is exposed, and to the depth of not more than 30 μm to prevent peeling of the vanadium diffusion layer.

Further alternatively, the high-hardness layer may be a diamond-like carbon layer. Preferably, the diamond-like carbon layer has a hardness in the range of Hv 1500 to 2000 to ensure high wear resistance of the valve seat. Preferably, the diamond-like carbon layer is formed to the depth of not less than 5 μm to prevent the diamond-like carbon layer from getting worn to such an extent that the base material is exposed, and to the depth of not more than 10 μm to prevent reduction in bond strength of the diamond-like carbon layer due to residual stress in the diamond-like carbon layer.

The concept of the present invention is also applicable to a chain tensioner further comprising a register ring elastically pressed against an outer periphery of the plunger and received in a ring receiving groove formed in an inner periphery of the cylinder, wherein a plurality of circumferential grooves are formed in the outer periphery of the plunger at predetermined axial intervals, the register ring being engageable in any of the circumferential grooves, wherein the circumferential grooves each comprise a tapered surface along which the register ring is slidable while radially expanding when the plunger 10 is pushed out of the cylinder, and a stopper surface for engaging the register ring when the plunger is pushed into the cylinder, thereby preventing the plunger from being pushed into the cylinder any further.

According to the present invention, since the externally threaded member is fixed in position with an adhesive, the externally threaded member never loosens and thus hydraulic oil never leaks, even if an operator inadvertently acts on the externally threaded member in such a manner as to loosen it.

### BRIEF DESCRIPTION OF THE DRAWINGS

Other features and objects of the present invention will become apparent from the following description made with reference to the accompanying drawings, in which:

FIG. 1 is a chain transmission device including a chain tensioner according to a first embodiment of the present invention;

FIG. 2 is an enlarged sectional view of the chain tensioner of FIG. 1 and its surrounding area;

FIG. 3 is an enlarged sectional view of the externally threaded member shown in FIG. 2 and its surrounding area;

FIG. 4 is an enlarged sectional view of a threaded portion of the externally threaded member of FIG. 3, and its surrounding area;

FIG. 5 is an enlarged sectional view of a contact surface of the valve seat of FIG. 2 to be brought into contact with the check ball, and its surrounding area;

FIG. 6 is an enlarged sectional view of a contact surface of the valve seat of FIG. 2 in contact with the screw rod, and its surrounding area; and

FIG. 7 is an enlarged sectional view of a chain tensioner according to a second embodiment of the present invention.

### DETAILED DESCRIPTION OF THE PREFERRED EMBODIMENTS

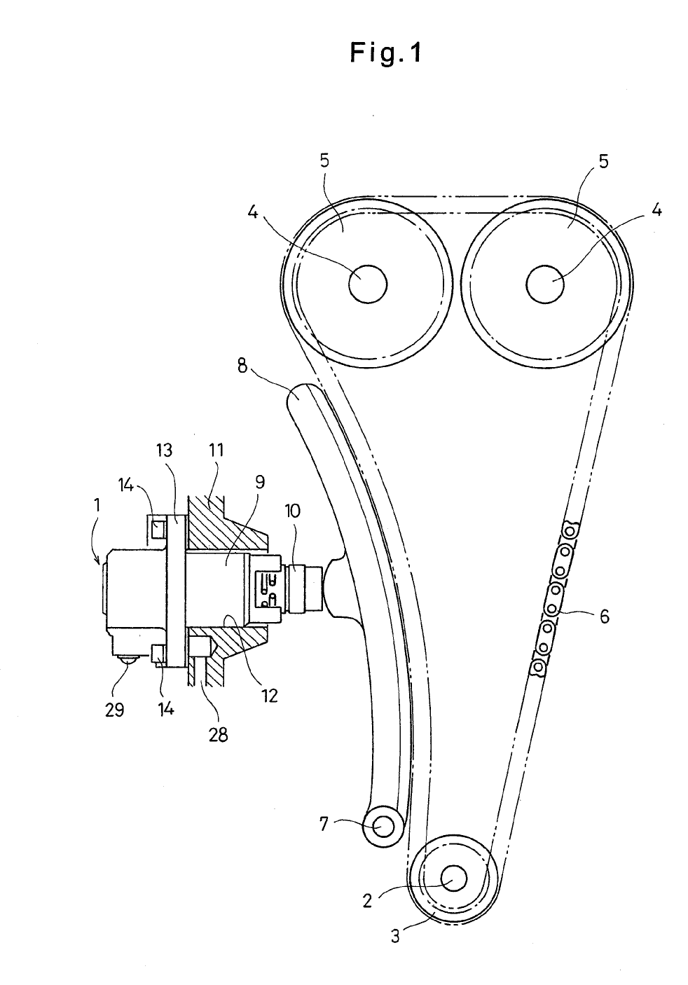

FIG. 1 shows a chain transmission device including a chain tensioner 1 according to the first embodiment of the present invention. The chain transmission device includes a sprocket 3 fixed to an engine crankshaft 2, sprockets 5 fixed to respective camshafts 4, and a chain 6 through which the sprockets 3 and 5 are coupled together. Thus, the rotation of the crankshaft 2 is transmitted to the camshafts 4, thereby rotating the camshafts 4 and opening and closing valves (not shown) of the combustion chambers.

A chain guide 8 which is pivotable about a pivot shaft 7 is kept in contact with the chain 6. The chain tensioner 1 presses the chain 6 through the chain guide 8.

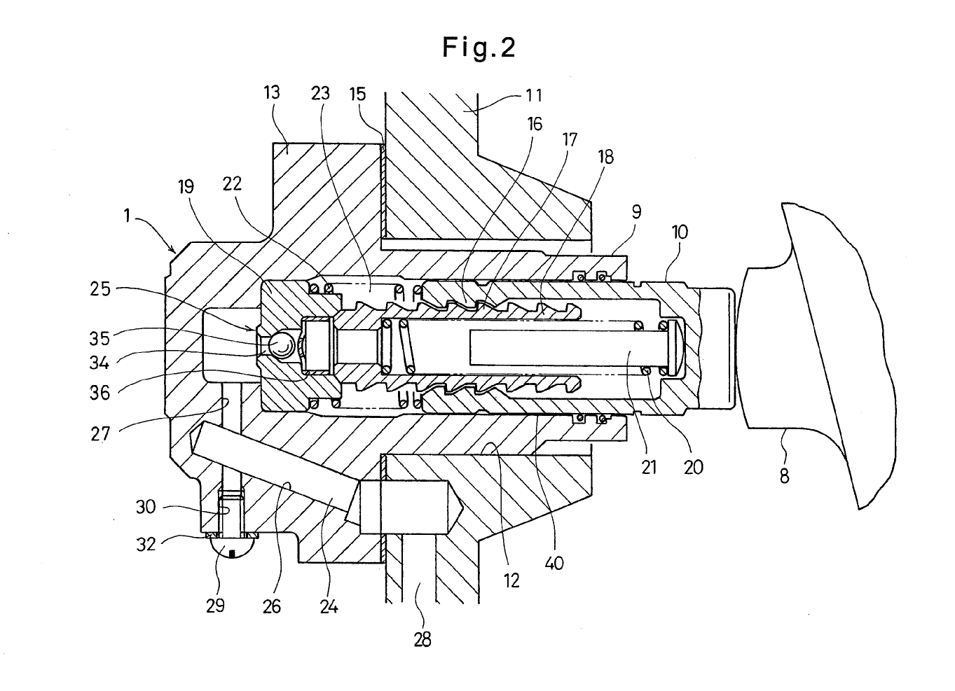

As shown in FIG. 2, the chain tensioner 1 includes a cylindrical cylinder 9 having an open end and a closed end, and a plunger 10 axially slidably inserted in the cylinder 9. The cylinder 9 is inserted in a tensioner mounting hole 12 formed in an engine cover 11 with its open end disposed in the interior of the engine cover 11. The cylinder 9 is integrally formed with a flange 13. The flange 13 is fixed to the outer surface of the engine cover 11 by means of bolts 14 shown in FIG. 1. A gasket 15 is interposed between the flange 13 and the engine cover 11.

The plunger 10 is a cylindrical member having a closed end and an open end located inside the cylinder 9, and formed with an internal thread 16 on its inner periphery. A screw rod 18 having an external thread 17 on its outer periphery is mounted in the plunger 10 with the external thread 17 in threaded engagement with the internal thread 16. The screw rod 18 has one end thereof protruding from the plunger 10 and supported on a valve seat 19 provided in the cylinder 9.

A return spring 20 is mounted between the plunger 10 and the screw rod 18. The return spring 20 has its one end supported by the screw rod 18 and presses at its other end the plunger 10 through a spring seat 21. The return spring 20 thus biases the plunger 10 outwardly of the cylinder 9. The plunger 10 is additionally biased outwardly of the cylinder 9 by an assist spring 22 mounted between the plunger 10 and the valve seat 19. At its end protruding from the cylinder 9, the plunger 10 is in abutment with the chain guide 8, thereby pressing the chain 6 through the chain guide 8.

The external thread 17 and the internal thread 16 each comprise a pressure flank for receiving pressure when a force that tends to push the plunger 10 into the cylinder 9 acts on the plunger 10, and a clearance flank, the pressure flank having a larger flank angle than the clearance flank. Thus, the threads 16 and 17 both have a serration-shaped axial section.

An oil supply passage 24 is formed in the flange 13 through which hydraulic oil is introduced into a pressure chamber 23 defined by the cylinder 9 and the plunger 10. At the outlet of the oil supply passage 24, a check valve 25 is provided to prevent backflow of hydraulic oil into the oil supply passage 24.

The oil supply passage 24 comprises a first hole portion 26 extending inwardly from a mating surface of the flange 13 facing the engine cover 11, and a second hole portion 27 extending from the outer periphery of the flange 13 to the pressure chamber 23, while intersecting the first hole portion 26 at its intermediate portion. The first hole portion 26 communicates with an oil hole 28 formed in the engine cover 11 and open to its outer surface. The end of the second hole portion 27 open to the outer periphery of the flange 13 is closed by an externally threaded member 29. Thus, hydraulic oil supplied from an oil pump (not shown) into the oil hole 28 is introduced into the pressure chamber 23 through the first hole portion 26 and then the second hole portion 27.

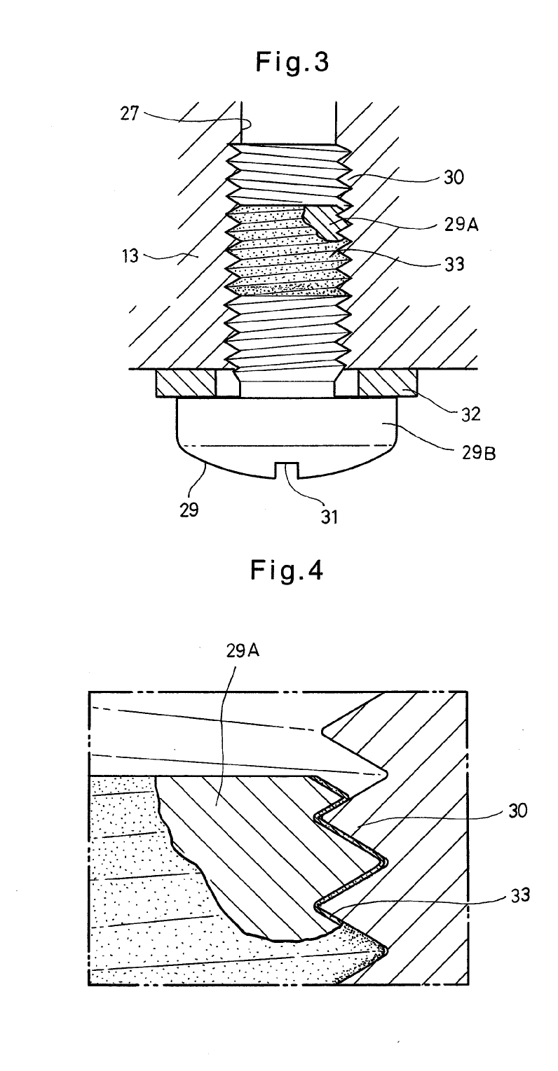

As shown in FIG. 3, the externally threaded member 29 comprises a threaded portion 29A that is brought into threaded engagement with an internal thread 30 formed on the inner periphery of the second hole portion 27, and a head 29B having a larger diameter than the second hole portion 27, and is integrally made of aluminum. A cross-shaped hole 31 is formed in the head 29B so that the externally threaded member 29 can be turned by engaging a screwdriver in the cross-shaped hole 31. A flat aluminum washer 32 is disposed between the head 29B and the flange 13. As shown in FIG. 4, an adhesive 33 is applied to the outer periphery of the threaded portion 29A to fix the threaded portion 29A to the internal thread 30, thereby preventing loosening of the externally threaded member 29.

As shown in FIG. 2, the check valve 25 comprises the valve seat 19, which is formed with a valve hole 34, a check ball 35 configured to contact and separate from the valve seat 19, thereby opening and closing the valve hole 34, and a retainer 36 for restricting the moving range of the check ball 35. The valve seat 19 is pressed into and fixed to the cylinder 9.

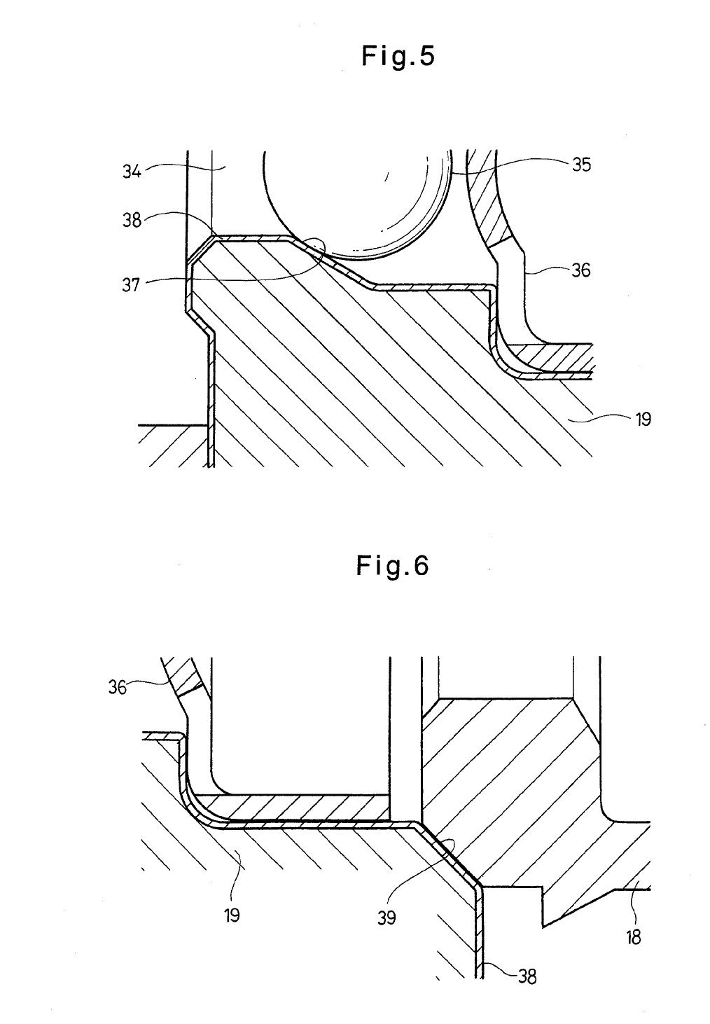

The valve seat 19 is formed by sintering or forging, and is hardened for increased strength. Further, as shown in FIG. 5, a high-hardness chrome diffusion layer 38 is formed on the contact surface 37 of the valve seat 19 to be brought into contact with the check ball 35. As shown in FIG. 6, the high-hardness chrome diffusion layer 38 is also formed on the contact surface 39 of the valve seat 19 to be brought into contact with the screw rod 18.

The portion of the chrome diffusion layer 38 formed on the contact surface 37 with the check ball 35, and the portion of the chrome diffusion layer 38 formed on the contact surface 39 with the screw rod 18 can be formed simultaneously by subjecting the valve seat 19 to chromizing treatment. The chrome diffusion layer 38 has a hardness in the range of Hv 1400 to 1800, and ensures high wear resistance of the valve seat 19.

The chrome diffusion layer 38 is preferably formed to the depth of not less than 5 μm and not more than 30 μm. By setting its thickness to not less than 5 μm, it is possible to prevent the chrome diffusion layer 38 from getting worn to such an extent that the base material is exposed. By setting its thickness to not more than 30 μm, it is possible to prevent peeling of the chrome diffusion layer 38.

Now the operation of this chain tensioner 1 is described.

While the engine is running, the plunger 10 moves back and forth as the chain 6 vibrates, and the check valve 25 repeatedly opens and closes with the back-and-forth movement of the plunger 10. When the tension of the chain 6 decreases, the plunger 10 protrudes from the cylinder under the biasing force of the return spring 20, thereby eliminating slackness of the chain 6. At this time, hydraulic oil supplied from the oil pump is introduced into the pressure chamber 23 through the oil supply passage 24, thereby quickly protruding the plunger 10.

When the tension of the chain 6 increases while the engine is running, the plunger 10 is pushed into the cylinder under the tension of the chain 6, thereby reducing the tension of the chain 6. At this time, hydraulic oil in the pressure chamber 23 leaks through a leakage gap 40 between the sliding surfaces of the plunger 10 and the cylinder 9. Thus, due to the dampening force produced when oil leaks through the leakage gap 40, the plunger 10 retracts slowly. At this time, the screw rod 18 rotates slowly as the chain 6 vibrates, thus allowing retraction of the plunger 10.

When the engine is stopped, according to the stopped positions of the cams (not shown) on the camshafts 4, the tension of the chain 6 may be kept high. But even in such a case, because the chain 6 does not vibrate while the engine is not running, the internal thread 16 of the plunger 10 is supported by the external thread 17 of the screw rod 18, so that the plunger 10 is fixed in position. This makes the chain 6 less likely to slacken while the engine is not running, thus permitting smooth startup of the engine when the engine is restarted.

In this chain tensioner 1, because the externally threaded member 29 is located outside the engine cover 11, an operator may inadvertently acts on the externally threaded member 29 in such a manner as to loosen it after the engine has been assembled. But since the externally threaded member 29 is fixed in position by the adhesive 33, it never loosens, and thus reliably prevents leakage of hydraulic oil from the second hole portion 27.

In this chain tensioner 1, when the externally threaded member 29 is screwed into the second hole portion 27, the flat aluminum washer 32, which is disposed between the head 29B of the externally threaded member 29 and the flange 13, is deformed and pressed tightly against the head 29B and the flange 13, thus increasing liquid tightness between the head 29B and the flange 13 and further reducing leakage of hydraulic oil.

Also, since the externally threaded member 29 is made of aluminum, if attempts are made to forcibly loosen the externally threaded member 29 by engaging a screwdriver in the cross-shaped hole 31 formed in the head 29B of the externally threaded member 29, the hole 31 will be easily broken, making it impossible to loosen the threaded member 29. This reliably prevents leakage of hydraulic oil due to such attempts.

In this chain tensioner 1, the portion of the chrome diffusion layer 38 formed on the contact surface 37 of the valve seat 10 to be brought into contact with the check ball 35 minimizes wear of the contact surface 37, thus minimizing the possibility of any gap being produced between the check ball 35 and the valve seat 19 when the valve hole 34 is closed by the check ball 35. This in turn makes it possible for the chain tensioner to stably perform its dampening function over a prolonged period of time.

The portion of the chrome diffusion layer 38 formed on the contact surface 39 of the valve seat 19 to be brought into contact with the screw rod 18 minimizes wear of the contact surface 39, thus minimizing increase in wear resistance between the screw rod 18 and the valve seat 19. Thus, when the tension of the chain 6 increases while the engine is running, the screw rod 18 rotates reliably, allowing the plunger 10 to reliably retract.

Since the portion of the chrome diffusion layer 38 on the contact surface 37 of the valve seat 10 to be brought into contact with the check ball 35 can be formed simultaneously when forming the portion of the chrome diffusion layer 38 on the contact surface 39 of the valve seat 19 to be brought into contact with the screw rod 18, the chrome diffusion layer 38 can be formed at a low cost.

In this embodiment, as the high-hardness layer formed on the surface of the valve seat 19, the chrome diffusion layer 38 is used. But the chrome diffusion layers 38 may be replaced with a vanadium diffusion layer. Such a vanadium diffusion layer preferably has a hardness of Hv 2000 to 2600 to ensure high wear resistance of the valve seat 19. The vanadium diffusion layer is preferably formed to the thickness of not less than 5 μm to prevent the vanadium diffusion layer from getting worn to such an extent that the base material is exposed. Also, the vanadium diffusion layer is preferably formed to the thickness of not more than 30 μm to prevent peeling of the vanadium diffusion layer.

Further alternatively, the chrome diffusion layer 38 may be replaced with a diamond-like carbon layer. Such a diamond-like carbon layer preferably has a hardness of Hv 1500 to 2000 to ensure high wear resistance of the valve seat 19. The diamond-like carbon layer is preferably formed to the thickness of not less than 5 μm to prevent the diamond-like carbon layer from getting worn to such an extent that the base material is exposed. Also, the diamond-like carbon layer is preferably formed to the thickness of not more than 10 μm to prevent reduction in bond strength of the diamond-like carbon layer due to residual stress in the diamond-like carbon layer.

The thread on the threaded portion 29A of the externally threaded member 29 may be a parallel thread but is preferably a tapered thread for improved liquid tightness of the threaded portion 29A.

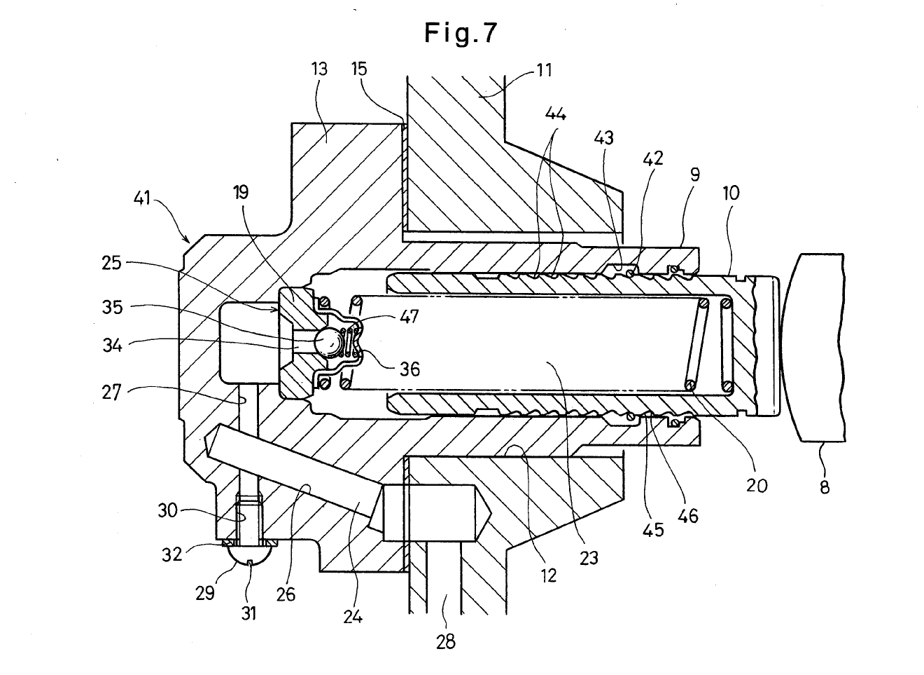

FIG. 7 shows the chain tensioner 41 according to the second embodiment of this invention. Elements corresponding to those of the first embodiment are denoted by identical numerals and their description is omitted.

A ring receiving groove 43 is formed in the inner periphery of the cylinder 9 in which a register ring 42 is received. The register ring 42 is elastically and radially inwardly pressed against the outer periphery of the plunger 10. A plurality of circumferential grooves 44 are formed in the outer periphery of the plunger 10 at axial intervals. The register ring 42 is engageable in any of the circumferential grooves 44.

Each circumferential groove 44 comprises a tapered surface 45 along which the register ring 42 is slidable while radially expanding when the plunger 10 is pushed out of the cylinder 9, and a stopper surface 46 for engaging the register ring 42 when the plunger 10 is pushed into the cylinder 9, thereby preventing the plunger 10 from being pushed into the cylinder 9 any further even if the tension of the chain 6 is high when the engine is stopped.

In order to improve the response of the check valve 25 to changes in pressure in the pressure chamber 23, a valve spring 47 is mounted between the check ball 35 and the retainer 36 to bias the check ball 35 toward the valve seat 19.

In the same manner as in the first embodiment, a high-hardness chrome-diffusion layer (not shown) is formed on the contact surface 37 of the valve seat 19 to be brought into contact with the check ball 35. The chrome diffusion layer has a hardness in the range of Hv 1400 to 1800, and is formed to the depth of not less than 5 μm and not more than 30 μm.

As in the first embodiment, this chain tensioner 41 also has the externally threaded member 29 fixed in position by the adhesive 33. Thus, even if an operator inadvertently acts on the externally threaded member 29 in such a manner as to loosen it, it never actually loosens, and thus reliably prevents leakage of hydraulic oil from the second hole portion 27.

Also as in the first embodiment, the chrome diffusion layer formed on the contact surface 37 of the valve seat 19 to be brought into contact with the check ball 35 minimizes wear of the contact, surface 37, thus minimizing the possibility of any gap being produced between the check ball 35 and the valve seat 19 when the valve hole 34 is closed by the check ball 35. This in turn makes it possible for the chain tensioner to stably perform its dampening function over a prolonged period of time.

What is claimed is:

1. A chain tensioner comprising a cylindrical cylinder having an open end and a closed end and inserted in a tensioner mounting hole formed in an engine cover with the open end located in an interior of the engine cover, said cylinder having a flange fixed to an outer surface of the engine cover;
a plunger axially slidably inserted in the cylinder;
wherein a pressure chamber is defined by the cylinder and the plunger, and the cylinder is formed with an oil supply passage through which hydraulic oil is introduced into the pressure chamber;
a check valve provided at an outlet of the oil supply passage for preventing backflow of hydraulic oil; and
a return spring biasing the plunger outwardly of the cylinder;
wherein said oil supply passage comprises a first hole portion extending inwardly from a mating surface of the flange facing the engine cover, and a second hole portion extending from an outer periphery of the flange to the pressure chamber and intersecting the first hole portion, said second hole portion having an internal thread formed on its inner periphery;
wherein said chain tensioner further comprises an externally threaded member having a threaded portion which is in threaded engagement with the internal thread formed on the inner periphery of the second hole portion, thereby closing an end of the second hole portion open to the outer periphery of the flange; and
wherein an adhesive is applied to the threaded portion of the externally threaded member, thereby fixing the externally threaded member in position.

2. The chain tensioner of claim 1 wherein said externally threaded member further comprises a head having a larger diameter than the second hole portion.

3. The chain tensioner of claim 2 further comprising an aluminum flat washer disposed between the head of the externally threaded member and the flange.

4. The chain tensioner of claim 2 wherein said externally threaded member is made of aluminum.

5. The chain tensioner of claim 1 wherein the threaded portion of the externally threaded member has a tapered thread.

6. The chain tensioner of claim 1 wherein said check valve comprises a valve seat formed with a valve hole, a check ball configured to be moved into and out of contact with the valve seat, thereby selectively opening and closing the valve hole, and a retainer for restricting the moving range of the check ball, wherein the chain tensioner further comprises a high-hardness layer comprising a first portion formed on a contact surface of the valve seat configured to be brought into contact with the check ball.

7. The chain tensioner of claim 6 wherein said plunger is a cylindrical member having a closed end and an open end that is located inside the cylinder and formed with an internal thread on its inner periphery, wherein said chain tensioner further comprises a screw rod mounted in the plunger with its one end protruding from the plunger and supported on the valve seat of the check valve, said screw rod having an external thread formed on its outer periphery and in threaded engagement with the internal thread of the plunger, the external thread of the screw rod and the internal thread of the plunger each comprising a pressure flank for receiving pressure when a force that tends to push the plunger into the cylinder acts on the plunger, and a clearance flank, the pressure flank having a larger flank angle than the clearance flank, whereby the external thread of the screw rod and the internal thread of the plunger have a serration-shaped axial section, and wherein said high-hardness layer further comprises a second portion formed on a contact surface of the valve seat that is in contact with the screw rod.

8. The chain tensioner of claim 6 wherein said high-hardness layer is a chrome diffusion layer.

9. The chain tensioner of claim 8 wherein said chrome diffusion layer has a hardness in the range of Hv 1400 to 1800.

10. The chain tensioner of claim 8 wherein said chrome diffusion layer is formed to the depth of 5 to 30 μm.

11. The chain tensioner of claim 6 wherein said high-hardness layer is a vanadium diffusion layer.

12. The chain tensioner of claim 11 wherein said vanadium diffusion layer has a hardness in the range of Hv 2000 to 2600.

13. The chain tensioner of claim 11 wherein said vanadium diffusion layer is formed to the depth of 5 to 30 μm.

14. The chain tensioner of claim 6 wherein said high-hardness layer is a diamond-like carbon layer.

15. The chain tensioner of claim 14 wherein said diamond-like carbon layer has a hardness in the range of Hv 1500 to 2000.

16. The chain tensioner of claim 14 wherein said diamond-like carbon layer is formed to the depth of 5 to 10 μm.

17. The chain tensioner of claim 1 further comprising a register ring elastically pressed against an outer periphery of the plunger and received in a ring receiving groove formed in an inner periphery of the cylinder, wherein a plurality of circumferential grooves are formed in the outer periphery of the plunger at predetermined axial intervals, said register ring being engageable in any of said circumferential grooves, wherein said circumferential grooves each comprise a tapered surface along which the register ring is slidable while radially expanding when the plunger is pushed out of the cylinder, and a stopper surface for engaging the register ring when the plunger is pushed into the cylinder, thereby preventing the plunger from being pushed into the cylinder any further.
